(19) United States
(12) Patent Application Publication
(10) Pub. No.: US 2011/0285851 A1
(43) Pub. Date: Nov. 24, 2011

(54) INTRUDER SITUATION AWARENESS SYSTEM

(75) Inventors: Tom Plocher, Hugo, MN (US); Henry Chen, Bejing (CN)

(73) Assignee: HONEYWELL INTERNATIONAL INC., Morristown, NJ (US)

(21) Appl. No.: 12/783,770

(22) Filed: May 20, 2010

(51) Int. Cl. G08B 13/00; H04N 7/18

(52) U.S. Cl. 348/152; 340/541; 348/E07.085

(57) ABSTRACT

An approach for detecting, tracking and capturing images of an intruder in a building. The intruder's bearing and speed, and structural information about the building may provide at least a partial basis for calculating potential paths of the intruder. Cameras along the anticipated paths may be selected. These cameras may be optimized to cover nearly any area where the intruder may appear. Location, one or more images, and possibly other information may provide an intruder situation awareness for display.

### BACKGROUND

The invention pertains to security of places, and particularly to the security of buildings. More particularly the invention pertains to an approach relative to one or more intruders in buildings.

### SUMMARY

The invention is an approach for detecting, tracking and capturing images of an intruder in a building. The intruder's bearing and speed, and structural information about the building may provide at least a partial basis for calculating anticipated paths of the intruder. Cameras along the anticipated paths may be selected. These cameras may be optimized to cover any area where the intruder may appear. Location, one or more images, and possibly other information may provide situation awareness for display.

### BRIEF DESCRIPTION OF THE DRAWING

FIG. 1 is a diagram of a floor in a building where an intruder may be moving about;

FIG. 2 is a diagram of a more specific look at an intruder's possible paths;

FIG. 3 is a diagram of an operation of an intruder situation awareness system; and

FIG. 4 is a block diagram of an illustrative example of the intruder situation awareness system.

### DESCRIPTION

Knowledge of building interior structures may be used to predict a path of one or more intruders, optimize cameras to track them, and generate a situation-awareness display. When an intruder is detected by, for instance, an access control lock breach or on a video camera, security personnel would like to track the intruder as he or she moves through the building from the point of entry. Since camera coverage is rarely complete in a building, maintaining continuity of a track of the intruder between camera views may be challenging.

The notion of tracking may in part be achieved by using semantic information about a building's internal structure. In this case, “semantic information” refers to the locations of and connectivity relationships between the building's doors, corridors, stairs, and elevators. Semantic information also refers to the location and properties of walls and like structures and the constraints to movement that they pose. These kinds of semantic information are used here to identify plausible paths that an intruder might take. This information may be combined with information from initial camera detection about an intruder's heading to refine and reduce the set of path possibilities. Cameras may then be cued to capture images of the intruder at a certain time and place in the building. The location and characteristics of cameras, access locks and other security devices are also a part of the semantic information. The characteristics of the cameras might include placement/location in XYZ coordinates, orientation, FOV, type of lens, type of control (fixed or PTZ), and so forth. This information together with semantic information about a building's internal structures may also be used to modify the camera parameters (i.e., PTZ) to better track the intruder, to avoid occlusions, to collaborate multiple cameras in capturing images with different perspectives of the intruder, and event-generate a situation-awareness display approach. The display may show a security guard the estimated location of the intruder on each predicted path at all times, including presence in an area occluded from camera views. From such a display the security guard can more easily anticipate which cameras he should be viewing and when he might expect to see the intruder appear in the one of the camera views. The present system may track several intruders at the same time.

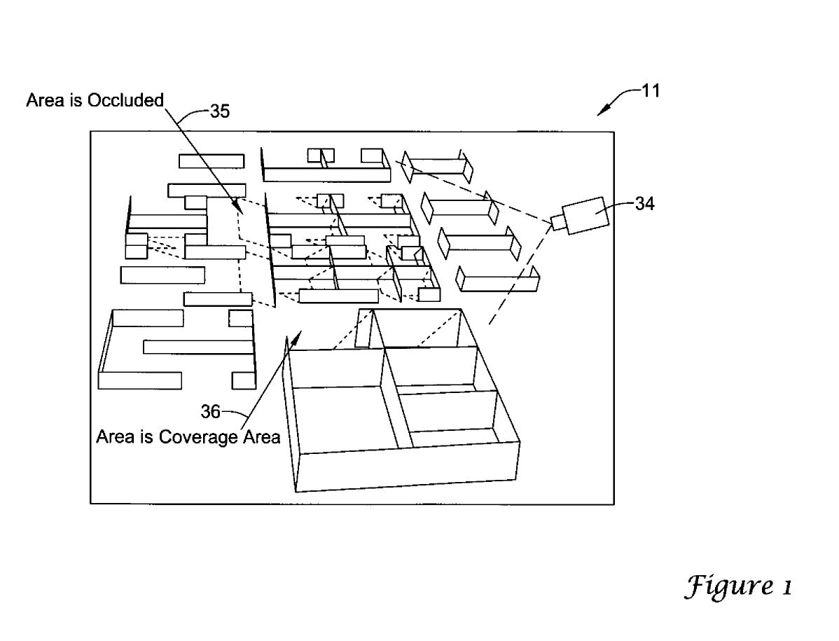

With the noted information, one may calculate the visible area of any camera via 3D transformation (FIG. 1). One may get a location update from a tracking sensor such as RSSI (received signal strength indication) tracking, dead reckoning tracking, or other tracking, or from video analytics technology. Additionally, with the topology constraints (e.g., walls not penetrable by people), one may predict a possible path in a building by an intruder. With information of this path, one may control virtually all PTZ-capable cameras so that one can obtain the best pictures of the intruder. This aspect may be formulized as an optimization. It may be a step in the present approach.

Specifically, when the position of an intruder is given, a 3D cylinder or cube around the position is assumed, and furthermore the cylinder or cube may be mapped into some pixels in the camera video. Consequently, an optimization may be depicted to maximize the number of the pixels in the video. The relative orientation between the camera and the intruder may also be considered in the optimization. The camera in front of the intruder may be preferred than the camera back of the intruder due to the intruder's face information with more importance. Correspondingly, the pixels from the front have more weight than the pixels from the back in the optimization. In case of a group of intruders, the optimization may be depicted to maximize the sum of the number of pixels in video for each intruder.

The term “best” herein means to at least try in an optimal fashion to follow the intruder, using multiple cameras focused on the intruder from different perspectives at the same time, and letting different cameras communicate with each other so as to follow the intruder or a group of intruders at same time from the best perspective. The parameters of cameras may be set via providing the optimization as indicated herein.

The term “best” herein means that when the intruder is in an occluded area (i.e., not visible to a camera), the building cameras may automatically focus on every possible area where the intruder could re-appear. And their parameters may be set in advance via providing the optimization.

With a predicted path, more situation-awareness may be provided for the surveillance display approach, such as drawing a historical path and a predicted path with different styles in a 3D scene and/or in video frames, popping up the best video (as estimated from camera parameters, building structure and intruder location) and linking it to the map or 3D scene, projecting the best video into the 3D scene, and so on.

For an example, an intruder or other kind of person may enter a floor of a building. There may be occluded and covered areas, as shown in FIG. 1. There may be cameras which may not be able to survey these areas. Thus, one does not necessarily have complete coverage. So the intruder's route may be anticipated since the intruder is not covered all of the time by surveillance cameras.

Semantic information on the building may be noted in anticipating the intruder's route. Semantic information may incorporate descriptions, plans and specifications of floors, walls, doors, hallways, offices, closets, restrooms, storage spaces, elevators, escalators, stairways, and other components of a building. With this information, anticipated paths of an intruder spotted at a certain place may be calculated. Much of the information utilized may be from a 3D building information model.

As an intruder enters the building, heading information, such as bearing and speed, of the intruder may be obtained. Cameras along the anticipated paths may be activated or directed in a way to obtain images of the intruder. A camera shot of the intruder may reveal bearing and direction of the intruder. However, a video of the intruder is not necessarily going to be possible in certain areas and along certain paths. Thus, surveillance video of the intruder may be lost for a period of time. Once the intruder exits a dead space (i.e., space that is not observable by any of the building's cameras), a camera proximate to the area where the intruder appears may pick up an image of the intruder. From the image and other information, anticipated routes of the intruder and estimated times of arrival at various points having a camera on the anticipated routes may again be calculated. If the intruder later arrives at a point on an anticipated or other route or path, anticipated routes or paths may be recalculated. An algorithm may be a tool for calculation of the anticipated routes, stops, and times of arrival, based at least partially on intruder movement and semantic information about the building. When the intruder is spotted by one or more cameras, various perspective views and tracking information of the intruder may provide identification and other items about the intruder. If the cameras are equipped with microphones and audio recording features, as well, then the cameras may also detect sounds from the intruder who talks to one or more people encountered along the path of movement. Other sounds from the intruder may incorporate distinct habitual noises (e.g., a cough). The video and sound captured by one or more cameras may be useful for entry in surveillance records or a database in case the intruder returns to the present building or enters some other facility. Video and sound of the intruder may also be useful for forensic analysis and as evidence if criminal and/or civil charges are to be made against the intruder.

FIG. 1 is a diagram of a floor 11 in a building where an intruder may be moving about. A camera 34 may be capturing images of an area of the intruder. Even though the intruder may appear to be in the field of view of camera 34, camera 34 would not necessarily capture an image of the intruder since the intruder may be in an occluded area 35 of the area within the field of view of camera 34. However, if the intruder is in a non-occluded area 36 within the field of view of camera 34, then an image of the intruder may be captured by the camera.

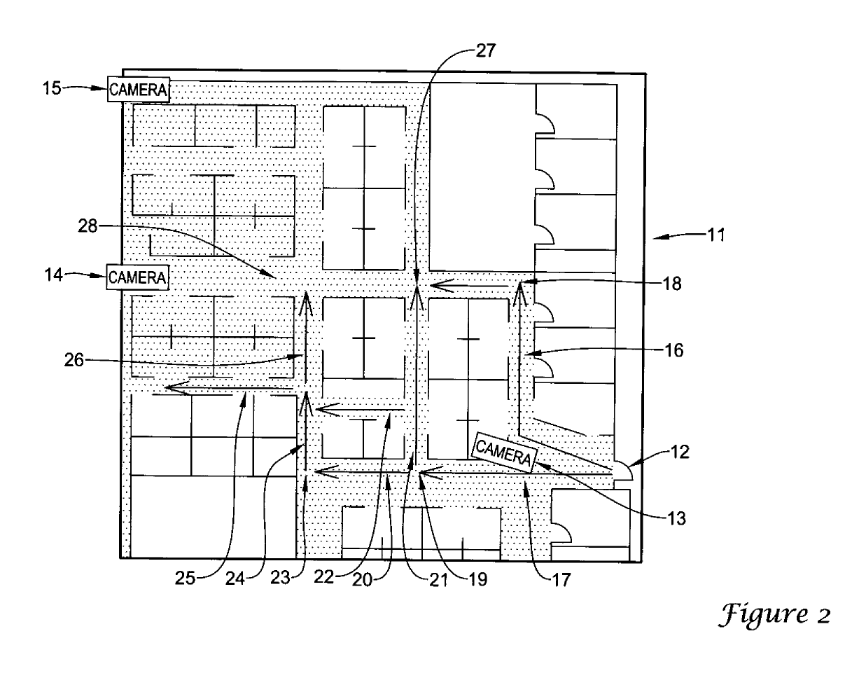

FIG. 2 is a diagram of a more specific look at intruder movement on floor 11. The intruder may breech an access lock and enter at a door 12. The access lock breech may be viewed on camera 13. From a video from camera 13, the bearing and speed of the intruder may be calculated. Given the topology of the floor 11, two paths 16 and 17 are possible. The bearing of the intruder toward the left of camera 13 suggests a greater likelihood of following path 16. However, since both paths 16 and 17 are occluded from camera view, the less likely path, 17, is still kept under consideration. The present system may reason that if the intruder is following path 16, then, based on his recorded speed, the intruder should emerge again into a camera view (camera 14) at time N at the hallway intersection 18. The camera view (camera 14) of intersection 18 may be given priority on a security guard's screen. If, on the other hand, the intruder is moving along the less likely path 17, the potential branching of routes appears more complicated. If, at hallway intersection 19, the intruder has turned right, the intruder may either follow path 21 to hallway intersection 27 or start down path 21 and then turn left onto path 22.

In the former case, the system may predict that the intruder will arrive in view again at intersection 27 at time N and will be in view of camera 14. The camera 14 view may also be given priority, but less so, on the security guard's screen. If the intruder does not arrive at intersection 18 or intersection 27 within X seconds of the predicted time, then camera 14 may be panned to the right and tilted to look for the intruder on one of the many possible paths, such as for example, from route 17 the intruder goes straight towards intersection 19 and then goes to path 20 towards intersection 23 to get to path 24. Other routes may include paths 25 and 26 associated with the less likely initial route 17. Simultaneously, camera 15 may be panned to the right and tilted appropriately to cover the possible arrival at intersections 27 and 28.

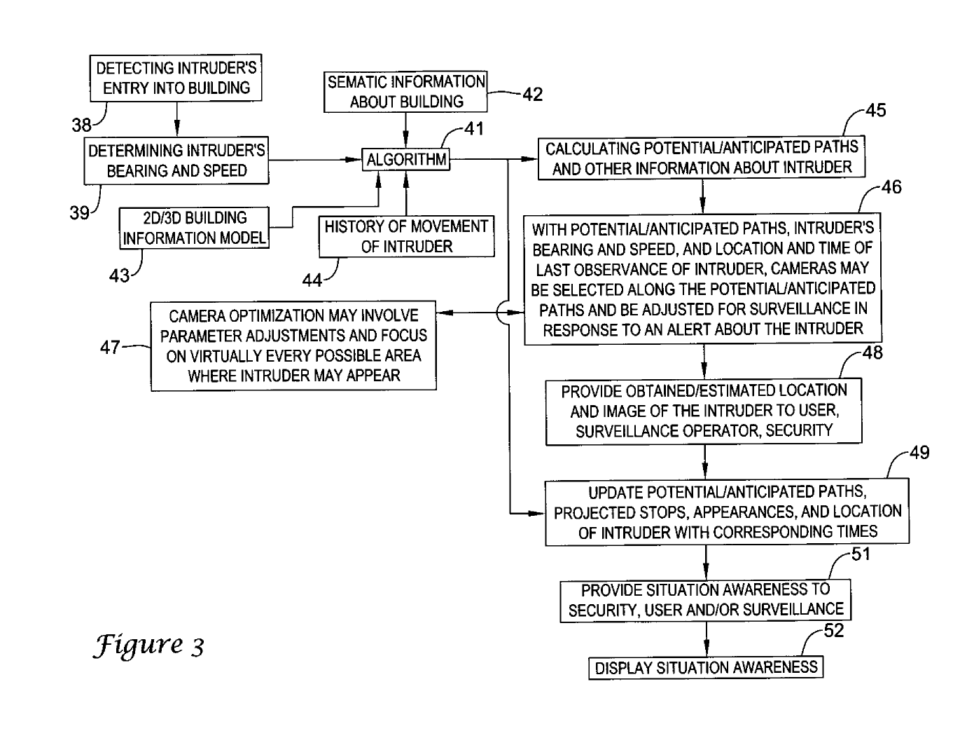

FIG. 3 is a diagram of the present approach. An entry of an intruder into a building may be detected at symbol 38. The intruder's speed and bearing may be determined at symbol 39 which may be provided to an algorithm 41. Semantic information about the building at symbol 42, a 2D and/or 3D building information model at symbol 43 and a history of movement of the intruder, if any exists, at symbol 44 may be provided to algorithm 41. At symbol 45, anticipated paths and other information about the intruder may be calculated with the aid of algorithm 41 and inputs from symbols 39 and 42, 43 and 44. At symbol 46, with a determination of the anticipated paths, the intruder's bearing and speed, and location and time of the last observance of the intruder, cameras may be selected along the anticipated paths and be adjusted in response to an alert about the intruder. Optimization at symbol 47 of the cameras (e.g., camera optimizer) may be provided, as indicated herein. The optimization may incorporate parameter adjustments and a focus on virtually every possible area where the intruder might appear. Optimization at symbol 47 may be in communication with camera selection and adjustment at symbol 46. At symbol 48, with possible information from symbol 46, a location and any image or images obtained or estimated of the intruder may be provided to a user, surveillance operator and/or security. At symbol 49, with possible information from symbols 47 and 48, there may be an updating of anticipated paths, predicted stops, appearances and locations of the intruder along with corresponding times for these items about the intruder. The information from symbol 49 may be provided as situation awareness about the intruder to the user, surveillance operator and/or security at symbol 51. The situation awareness may be displayed at symbol 52. The present approach may be applicable to numerous intruders and various kinds of persons.

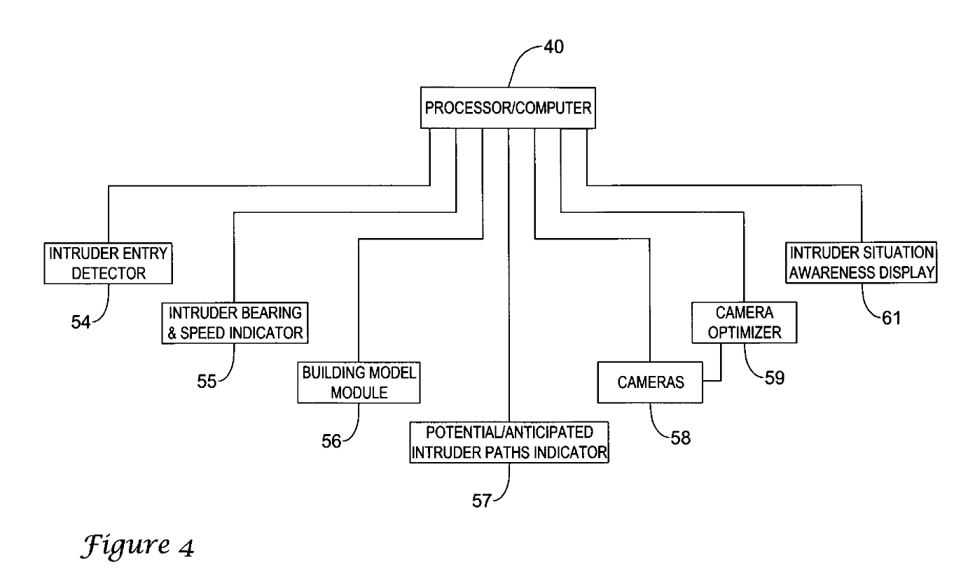

FIG. 4 is a block diagram of an illustrative example of an intruder situation awareness system. An intruder entry detector 54, an intruder bearing and speed indicator 55, and a building model module 56 may be connected to a processor/computer 40. An anticipated intruder paths indicator 57, cameras 58 and a camera optimizer 59 may be connected to processor/computer 40. Camera optimizer 59 may be connected to cameras 58. An intruder situation awareness indicator may be connected to processor/computer 40. The intruder entry detector 54, the intruder heading and speed indicator 55, the building model module 56, the anticipated intruder paths indicator 57, cameras 58, the camera optimizer 59 and the intruder situation awareness display 61 may be interconnected to one another via the processor/computer 40. Relevant patent documents may include U.S. Pat. No. 7,683,793, issued Mar. 23, 2010, and entitled “Time-Dependent Classification and Signaling of Evacuation Route Safety”; U.S. patent application Ser. No. 12/200,158, filed Aug. 28, 2008, and entitled “Method of Route Retrieval”; and U.S. patent application Ser. No. 12/573,398, filed Oct. 5, 2009, and entitled “Location Enhancement System and Method Based on Topology Constraints”. U.S. Pat. No. 7,683,793, issued Mar. 23, 2010, is hereby incorporated by reference. U.S. patent application Ser. No. 12/200,158, filed Aug. 28, 2008, is hereby incorporated by reference. U.S. patent application Ser. No. 12/573,398, filed Oct. 5, 2009, is hereby incorporated by reference.

In the present specification, some of the matter may be of a hypothetical or prophetic nature although stated in another manner or tense.

Although the present system has been described with respect to at least one illustrative example, many variations and modifications will become apparent to those skilled in the art upon reading the specification. It is therefore the intention that the appended claims be interpreted as broadly as possible in view of the prior art to include all such variations and modifications.

What is claimed is:

1. A method for tracking one or more intruders in a building, comprising:
detecting entry of an intruder into a building;
calculating bearing and speed of the intruder;
retrieving semantic information about the building;
calculating one or more potential paths of the intruder based on the semantic information about the building and on the bearing of the intruder;
calculating transit times between endpoints of the one or more potential paths based on the speed of the intruder and the semantic information about building that affect transit time along the one or more potential paths;
providing surveillance of the one or more potential paths at estimated times of presence on the one or more potential paths;
obtaining one or more images and locations of the intruder when available with one or more surveillance devices; and/or
providing a situation awareness display from the one or more images when available of the intruder.

2. The method of claim 1, wherein the semantic information comprises:
locations of doors, corridors, stairs, elevators and other components in the building;
connectivity relationships among the doors, corridors, stairs, elevators and other components in the building;
locations of constraints and walls resistant to movement of an intruder in the building;
properties of the constraints and walls resistant to movement of an intruder in the building;
locations of components for movement by the intruder from one level in the building;
movement times of the intruder associated with components for moving from one level in the building;
locations of surveillance devices, access locks and/or other security devices; and/or
characteristics of surveillance devices, access locks and/or other security devices in the building.

3. The method of claim 1, wherein the surveillance devices comprise selected cameras for observing movement along the one or more potential paths.

4. The method of claim 3, wherein the selected cameras are optimized to cover virtually every possible area where the intruder may appear along the one or more potential paths.

5. The method of claim 3, wherein the selected cameras have parameters adjusted to provide best camera coverage of the intruder wherever and at whatever time the intruder is predicted to appear along the one or more potential paths.

6. The method of claim 3, wherein:
a field of view of a selected camera extends over an occluded area and a non-occluded area; and
the non-occluded area is a visible area of camera coverage.

7. The method of claim 1, wherein the situation awareness is provided on a display and includes at least a 2D and/or a 3D map of the building on which intruder-related information is overlaid.

8. The method of claim 7 wherein the intruder-related information overlaid on the 2D and 3D maps comprises:
a point of entry to the building by the intruder;
speed and bearing of the intruder;
the one or more potential paths of the intruder and transit times between the endpoints of the one or more potential paths;
estimated locations of the intruder along the one or more potential paths at virtually any time;
camera locations along the one or more potential paths;
indicated occluded and non-occluded areas along the one or more potential paths; and
past paths taken by the intruder and transit times of the intruder through the past paths.

9. The method of claim 1, further comprising:
updating the bearing and speed of the intruder;
updating the one or more potential paths;
updating transit times between path endpoints of the one or more potential paths; and
updating the one or more images and locations of the intruder.

10. The method of claim 1, wherein:
images and locations obtained of the intruder are saved as a history of movement of the intruder; and
a history of movement is incorporated in an update of calculating the one or more potential paths of the intruder;
preferences of paths by the intruder are incorporated in an update of calculating the one or more potential paths of the intruder
transit times by the intruder having traversed the one or more paths are incorporated into an update of speed of the intruder and used in calculating transit times for additional one or more potential paths.

11. The method of claim 6, wherein the occluded and non-occluded areas of a selected camera are determined from a 3D model of the building and parameters of the selected camera.

12. The method of claim 3, wherein selected cameras are cued to capture images of the intruder at certain times and places in the building.

13. An intruder situation awareness system for a building, comprising:
an intruder entry detector for a building;
a bearing and heading detector;
a building information model module;
a module for calculating one or more potential paths of an intruder and estimated speed of movement of the intruder, connected to the bearing and heading detector and the building information model module; and
a module for calculating transit times between endpoints of the one or more potential paths based on estimated speed of movement of the intruder.
a plurality of cameras situated in the building, connected to the module for calculating the one or more potential paths and estimated speed of movement of the intruder; and
wherein a set of cameras proximate to the one or more potential paths are selected from the plurality of cameras by the module for calculating one or more potential paths of an intruder and estimated speed of the intruder.

14. The system of claim 13, wherein the set of cameras are for obtaining an image of the intruder.

15. The system of claim 14, wherein a location of the intruder is inferred from an image of the intruder captured by a certain camera of the set of cameras.

16. The system of claim 15, wherein:
the location and image of the intruder is a basis for a situation awareness of the intruder; and
the situation awareness is presentable on a display.

17. The system of claim 13, wherein:
a field of view of nearly each camera of the plurality of cameras extends over an occluded area and/or a non-occluded area of the building;
the non-occluded area is a visible area of camera coverage; and
the set of cameras are optimized with parameter adjustments to provide camera coverage of nearly every possible area where the intruder may appear.

18. The system of claim 16, wherein:
the system is for tracking two or more intruders; and
different cameras of the set of cameras communicate among each other to follow two or more intruders at the same time.

19. An intruder situation awareness system for tracking one or more intruders in a building, comprising:
a processor;
an intruder entry detector connected to the processor;
a building model module connected to the processor;
a one or more potential intruder paths indicator connected to the processor; and
a plurality of cameras connected to the processor; and
wherein:
the building model module contains structural information about the building;
the one or more intruder paths indicator reveals paths that the intruder might take while moving about in the building;
one or more cameras of the plurality of cameras are selected along the one or more intruder paths; and
the processor computes intruder situation awareness information from the bearing and heading indicator, the building model module and the one or more cameras, to indicate likely locations of an intruder or intruders in the building.

20. The approach of claim 19, further comprising:
a camera optimizer connected to the plurality of cameras and the processor; and
a screen connected to the processor for displaying intruder situation awareness information; and
wherein the intruder entry detector, intruder bearing and speed indicator, the building model module, the one or more potential intruder paths indicator, the plurality of cameras, the camera optimizer and the intruder situation awareness display are connectable to one another through the processor.
